(19) United States
(12) Patent Application Publication
(10) Pub. No.: US 2015/0113586 A1
(43) Pub. Date: Apr. 23, 2015

(54) RADIO FREQUENCY AND FIBER OPTIC SUBSCRIBER DROP EQUIPMENT HAVING IMPACT RESISTANT HOUSINGS AND RELATED HOUSINGS AND METHODS

(71) Applicant: CommScope, Inc. of North Carolina, Hickory, NC (US)

(72) Inventors: Shi Man Li, Mooresville, NC (US); Robert R. Riggsby, Charlotte, NC (US); Robert E. Darrow, Raleigh, NC (US); Chi-Min Kang, Touchen (TW); Jui-Huang Chung, Taipei City (TW)

(21) Appl. No.: 14/520,464

(22) Filed: Oct. 22, 2014

Related U.S. Application Data
(60) Provisional application No. 61/894,500, filed on Oct. 23, 2013.
(60) Provisional application No. 61/911,551, filed on Dec. 4, 2013.

(51) Int. Cl. H04N 7/10; H04N 21/61

(52) U.S. Cl. CPC H04N 7/102; H04N 21/6118
USPC 725/129

(57) ABSTRACT

Subscriber drop units include a housing having a top wall that has an exterior surface and an interior surface and a plurality of sidewalls that extend downwardly from the top wall, the top wall and the sidewalls defining an interior cavity. An input port and at least one output port extend through the housing. A printed circuit board is mounted within the interior cavity. The exterior surface of the top wall includes a first ridge that extends upwardly above a first of the sidewalls and a second ridge that extends upwardly above a second of the sidewalls

### CROSS-REFERENCE TO RELATED APPLICATIONS

The present application claims priority under 35 U.S.C. §119 to U.S. Provisional Application Ser. No. 61/894,500, filed Oct. 23, 2013 and to U.S. Provisional Application Ser. No. 61/911,551, filed Dec. 4, 2013, the entire content of each of which is incorporated herein by reference as if set forth in its entirety.

### FIELD OF THE INVENTION

The present invention relates to communications networks and, more particularly, to radio frequency (“RF”) and fiber optic subscriber drop equipment that is used, for example, in hybrid fiber-coaxial communications networks.

### BACKGROUND

Cable television networks are communications networks that are used to transmit cable television signals and/or other information between one or more service providers and a plurality of subscribers, typically over coaxial and/or fiber optic cables. Most conventional cable television networks comprise hybrid fiber-coaxial networks. In these networks, fiber optic cables are typically used to carry signals from the headend facilities of the service provider to various distribution points, while less expensive coaxial cable may be used, for example, to carry the signals into neighborhoods and/or into individual buildings.

Typically, the service provider is a cable television company that may have exclusive rights to offer cable television services in a particular geographic area. Subscribers to the cable television network may have cable television services provided to, for example, individual homes, apartments, hotels, businesses, schools, government facilities and the like, which are referred to as “subscriber premises.” The service provider may broadcast a variety of cable television channels to these subscriber premises over the cable television network. Most cable television service providers also offer other services such as, for example, broadband Internet service and digital telephone service. Thus, in many cases, a subscriber of the service provider may receive cable television service, a broadband Internet connection, and Voice-over-Internet Protocol (“VoIP”) Internet telephone service all through a single connection between the service provider and the subscriber premise.

Cable television networks are typically implemented as point-to-multi-point networks in order to deliver cable television signals, broadband Internet service and the like from the headend facilities to the subscriber premises. Typically, trunk, district and feeder sections are used to deliver the signals from the headend to individual neighborhoods and the like. So-called “drop sections” are then used to distribute the signals from the feeder sections into the individual neighborhoods.

In the drop sections, tap units are typically connected in series along communications lines (e.g., a coaxial cable) of the cable television network to provide service to individual subscriber premises. Amplifiers may also be provided along these communications lines to increase the power of the downstream and/or upstream signals. The tap units typically have an input port that connects to a first segment of the communications line, an output port that connects to a second segment of the communications line, and one or more RF tap ports. Cables, such as, for example, coaxial cables, may run between each RF tap port of a tap unit and a respective subscriber premise. In this manner, each RF tap port acts as a branch off of the communications line that is used to provide a communications path between the service provider and an individual subscriber premise over the cable television network.

In residential applications, an RF signal amplifier may be provided at many individual subscriber premises that is used to amplify the RF signal received over the RF connection between the cable television network and the subscriber premises (the downstream connection). In some cases, the RF signal amplifier may also amplify any RF signals that are transmitted in the reverse (upstream) direction from the subscriber premise to the cable television network (note that broadband Internet and Internet telephone service both involve full duplex transmissions, as does some types of cable television service such as pay-per-view service). These RF signal amplifiers typically include an RF input port that is connected to an RF tap port of a tap unit by, for example, a coaxial cable, and at least one RF output port. Directional couplers, splitters, inline filters, MOCA rejection filters and other signal conditioning or signal routing hardware may also be provided in the drop sections, typically at or near individual subscriber premises. The RF equipment that is included in the drop sections of a cable television network such as the above-described tap units, amplifiers, direction couplers, splitters, inline filters, MOCA rejection filters and the like is referred to herein as “RF subscriber drop equipment” or as “RF subscriber drop units.”

Subscribers to cable television networks are increasingly streaming large amounts of video content such as movies, television shows, videos and the like to television sets, computers, tablets and other electronic devices. Because of the increased bandwidth required to support such video streaming, there is growing interest in providing fiber optic communications in at least part of the drop sections of cable television networks or even all of the way to each subscriber premise, as fiber optic cables can support much higher data rate communications than coaxial cables, particularly for communications over longer distances. The expansion of the fiber portions of cable television networks may require installation of a large number of fiber optic network devices in the drop sections of new and existing cable television networks. Such equipment is referred to herein as “fiber optic subscriber drop equipment.” Fiber optic subscriber drop equipment may include, for example, optical micro nodes and optical network units that convert downstream optical signals to RF signals and which convert upstream RF signals to optical signals. Typically the fiber optic subscriber drop equipment may be installed within or just outside individual subscriber premises.

RF and fiber optic subscriber drop equipment (which is referred to generically herein as “subscriber drop equipment”) is field-installed equipment that may be damaged during field installation or during use at the subscriber premises. Such damage can result in service calls, equipment replacement and the like, thereby increasing the costs associated with operating the cable television network.

### SUMMARY

Pursuant to embodiments of the present invention, subscriber drop units are provided that include a housing having a top wall that has an exterior surface and an interior surface and a plurality of sidewalls that extend downwardly from the top wall, the top wall and the sidewalls defining an interior cavity. An input port and at least one output port extend through the housing. A printed circuit board is mounted within the interior cavity. The exterior surface of the top wall includes a first ridge that extends upwardly above a first of the sidewalls and a second ridge that extends upwardly above a second of the sidewalls.

In some embodiments, the top wall may include a plurality of protrusions that extend downwardly from the interior surface thereof into the interior cavity, and the printed circuit board may be mounted on these protrusions. At least two of the sidewalls may have printed circuit board mounting features on interior surfaces thereof, and the printed circuit board may be mounted on these printed circuit board mounting features. In exemplary embodiments, the first and second ridges may each have a height of at least 2 millimeters and/or a width of at least two millimeters. The first and second ridges may have hollow interiors. The first and second ridges may be configured to transfer at least half the force imparted on the first and second ridges when a vertical force is imparted on top surfaces of the first and second ridges to the first and second sidewalls.

Pursuant to further embodiments of the present invention, subscriber drop units are provided that have a housing having a top wall and a plurality of sidewalls that extend downwardly from the top wall, the top wall and the sidewalls defining an interior cavity, the top wall including a plurality of protrusions that extend downwardly from an interior surface of the top wall. An input port and at least one output port extend through the housing. A printed circuit board is mounted on the plurality of protrusions within the interior cavity. An exterior surface of the top wall has a plurality of ridges.

In some embodiments, a first of the plurality of ridges may extend upwardly from the top wall at least partially above a first of the sidewalls and a second of the plurality of ridges may extend upwardly from the top wall at least partially above a second of the sidewalls. A first height of an exterior sidewall of a first of the ridges may exceed a second height of an interior sidewall of the first of the ridges. The protrusions may be posts. The ridges may have hollow interiors.

Pursuant to still further embodiments of the present invention, subscriber drop units are provided that have a housing having a top wall that has an exterior surface and an interior surface and a plurality of sidewalls that extend downwardly from the top wall, the top wall and the sidewalls defining an interior cavity, at least two of the sidewalls having printed circuit board mounting features on interior surfaces thereof. An input port and at least one output port extend through the housing. A printed circuit board is mounted within the interior cavity on the printed circuit board mounting features of the at least first and second of the sidewalls. The exterior surface of the top wall has a plurality of ridges.

In some embodiments, the printed circuit board mounting features may be at least one mounting tab on the first of the sidewalls that extends inwardly from the first of the sidewalls into the interior cavity and at least one mounting tab on the second of the sidewalls that extends inwardly from the second of the sidewalls into the interior cavity. In other embodiments, the printed circuit board mounting features comprise a first ledge in the interior surface of a first of the sidewalls and a second ledge in the interior surface of a second of the sidewalls. A first of the plurality of ridges may extend upwardly from the top wall at least partially above a first of the sidewalls and a second of the plurality of ridges may extend upwardly from the top wall at least partially above a second of the sidewalls.

Pursuant to additional embodiments of the present invention, subscriber drop units are provided that include a housing having a top wall and a plurality of sidewalls that extend downwardly from the top wall, the top wall and the sidewalls defining an interior cavity and the housing having an open bottom. A cover plate covers the open bottom of the housing. A printed circuit board is mounted within the interior cavity. A bridge support having first and second legs and a span extending therebetween is also provided, where the span is positioned adjacent the cover plate and the first and second legs are positioned adjacent an interior surface of the top wall of the housing.

In some embodiments, the printed circuit board may be mounted between the first leg and the second leg. The span may include at least one upwardly extending protrusion such as, for example, a ridge that extends from the first leg to the second leg. The span may be arch-shaped. The ridge may contact an interior surface of the cover plate. An exterior surface of the top wall includes a first ridge that extends upwardly above a first of the sidewalls and a second ridge that extends upwardly above a second of the sidewalls. The top wall may include a plurality of protrusions that extend downwardly from the interior surface of the top wall into the interior cavity. The printed circuit board may be mounted on these protrusions. The bridge support may be formed of a polymeric material. The bridge support may also include at least one support rib that has a first end that is connected to one of the first or second legs and a second end that is connected to a portion of the span that is between the first and second legs.

Pursuant to still additional embodiments of the present invention, subscriber drop units are provided that include a housing having a top wall and a plurality of sidewalls that extend downwardly from the top wall, the top wall and the sidewalls defining an interior cavity and the housing having an open bottom. A cover plate covers the open bottom of the housing. A printed circuit board is mounted within the interior cavity. A polymeric support is mounted within the interior cavity that has a first end that is in direct contact with an interior surface of the cover plate and a second end that is in direct contact with an interior surface of the top wall.

In some embodiments, the polymeric support may have first and second legs and a span extending therebetween. The span may be an arch-shaped span that includes at least one upwardly extending protrusion. The protrusion may be a ridge that extends from the first leg to the second leg. An exterior surface of the top wall may include a first ridge that extends upwardly above a first of the sidewalls and a second ridge that extends upwardly above a second of the sidewalls. The top wall may include a plurality of protrusions that extend downwardly from the interior surface of the top wall into the interior cavity, and the printed circuit board may be mounted on the plurality of protrusions between the first leg and the second leg.

### BRIEF DESCRIPTION OF THE DRAWINGS

FIG. 1 is a side perspective view of an RF subscriber drop unit according to embodiments of the present invention.

FIG. 2 is a top perspective view of the RF subscriber drop unit of FIG. 1.

FIGS. 3A-3M are various perspective, top, bottom, side and sectional views of the RF subscriber drop unit of FIGS. 1 and 2 or elements thereof.

FIGS. 4A-4B are a top perspective view and a bottom perspective view, respectively, of an RF subscriber drop unit according to further embodiments of the present invention.

FIGS. 5A-5E are schematic perspective views of housings for RF subscriber drop units according to still further embodiments of the present invention that have alternative ridge designs.

FIG. 6 is a bottom view of a housing for an RF subscriber drop unit according to still further embodiments of the present invention.

FIG. 7 is a bottom view of a housing for an RF subscriber drop unit according to additional embodiments of the present invention.

FIG. 8 is a perspective view of a bridge support according to embodiments of the present invention.

FIG. 9 is a cross-sectional perspective view of an RF subscriber drop unit according to further embodiments of the present invention that includes the bridge support of FIG. 8.

FIG. 10 is a perspective view of a bridge support according to further embodiments of the present invention.

FIG. 11 is a perspective view of a bridge support according to still embodiments of the present invention.

FIG. 12 is a perspective view of a bridge support according to yet further embodiments of the present invention.

FIG. 13 is a perspective view of a bridge support according to yet another embodiment of the present invention.

FIGS. 14A-14D illustrate a fiber optic subscriber drop unit in the form of a micro node according to further embodiments of the present invention.

### DETAILED DESCRIPTION

Drop equipment such as filters, micro nodes, splitters and directional couplers, signal amplifiers and the like that are utilized in hybrid fiber-coaxial networks may be subject to impact forces during installation or in normal usage. These impact forces can damage or destroy sensitive fiber optic and/or electronic components that are contained in these units. For example, during installation, micro nodes, signal amplifiers, splitters and/or directional couplers are often mounted on the sides of buildings or enclosures to provide convenient access to technicians who need to attach fiber optic and/or coaxial cables to the input and output ports thereof. Typically, the housing of such subscriber drop unit will include a plurality of mounting apertures that are designed to receive nails or screws that are used to mount the unit to a mounting surface such as a wall of a building. An installer may then use a hammer or drill to install the nails or screws through the mounting apertures and into the mounting surface. Unfortunately, it is far too common that an installer may incorrectly aim the hammer during the installation process and hit the top surface of the housing of the subscriber drop unit instead of the nail during the installation process. This may damage or even destroy the subscriber drop unit. Cover plates that are routinely used to cover the open bottom of the housing of various subscriber drop units may also be susceptible to damage from impact forces.

Subscriber drop units may be particularly susceptible to damage when the exterior surface of the top wall of the housing thereof receives a blow because a printed circuit board that includes delicate RF and/or fiber optic circuits is often mounted to an interior surface of one of the sidewalls or the top wall of the housing. For example, many conventional subscriber drop units include a plurality of pillars or “posts” that extend downwardly from the interior surface of the top wall of the housing. These posts may, in some cases, have distal ends that are internally threaded. In such designs, the printed circuit board may be mounted within the housing via a plurality of screws that are received within the internally-threaded pillars. In other designs, walls, posts or other protrusions may extend downwardly from the interior surface of the top wall and the printed circuit board may be mounted to these protrusions via, for example, soldered connections. In all of the above-described subscriber drop units, impact forces that are applied to the exterior surface of the top wall such as the aforementioned hammer blows tend to be transferred via these posts or other protrusions from the top wall to the printed circuit board, which has sensitive electronic equipment and fragile soldered electrical connections thereon. In order to protect the printed circuit board and internal electronics from damage when such impact forces are applied to the housing, prior art housing designs have tended to employ thicker metal housings that are capable of absorbing greater forces. This approach, however, can increase the cost and weight of the subscriber drop unit.

The optical connectors in fiber optic subscriber drop units may also be damaged by impact forces. For example, fiber optic subscriber drop units will typically include one or more connections where a fiber optic cable connects to an input port or output port on the fiber optic subscriber drop unit. The optical fiber in the fiber optic cable should be precisely aligned with a mating fiber, waveguide or the like of the fiber optic subscriber drop unit at these connections. Impact forces may misalign these connections, which can result in severe attenuation of the optical signals. Impact forces may also result in cracks in the housing of both RF and fiber optic subscriber drop units which can expose the interior of the unit to environmental factors such as moisture.

Pursuant to embodiments of the present invention, RF and optical fiber subscriber drop units are provided that may be more resistant to damage from impact forces that may be applied during installation or use. The subscriber drop units according to embodiments of the present invention may have a housing that has a top wall and a plurality of sidewalls that extend downwardly from outer edges of the top wall. Interior surfaces of the sidewalls and top walls define an interior cavity that has an open bottom. A cover plate may be provided that may be attached to the sidewalls to cover the open bottom. A plurality of protrusions such as internally-threaded or unthreaded posts may extend downwardly from an interior surface of the top wall. A printed circuit board or other mounting substrate may be mounted on these protrusions within the interior cavity of the housing. A plurality of ridges are provided on the exterior surface of the top wall. These ridges may absorb at least part of the force of a hammer blow or other force that impacts the exterior surface of the top wall of the housing, and may divert at least some of the received force away from the printed circuit board or other mounting substrate that is mounted to the interior surface of the top wall via the above-mentioned posts or other protrusions.

In some embodiments, the ridges that extend from the exterior surface of the top wall of the housing may extend upwardly from (or near) outer edges of the top wall so that the ridges are at least partly located over one or more of the sidewalls of the housing. This arrangement may facilitate transferring forces received by the ridges to the sidewalls of the housing, which may reduce the amount of force that is transferred to the printed circuit board. In some embodiments, the spacing between adjacent ridges that extend upwardly from the top wall may be less than a predetermined amount. For example, adjacent ridges may be spaced close enough together so that the head of a hammer will not fit in between adjacent ridges.

In other embodiments, the printed circuit board may be mounted on a ledge that extends around the interior surfaces of the sidewalls of the housing or on tabs or other mounting surfaces that project inwardly from the interior surfaces of the sidewalls of the housing. The ledge, tabs or the like may replace or supplement the protrusions that extend downwardly from the top wall. In some embodiments, the ridges that extend upwardly from the top wall may be positioned above two of the sidewalls and the printed circuit board may be mounted on a ledge or mounting tabs that extend from two other sidewalls of the housing. This may reduce the amount of force that is transferred to the printed circuit board when an impact force is applied to one of the ridges.

A second portion of the housing of conventional subscriber drop units that may be susceptible to damage is the cover plate that covers the bottom surface of the housing. In some subscriber drop units, the bottom edge of the housing may include a channel and the cover plate may include a lip about its periphery that fits within the channel. In such embodiments, once assembly of the internal electronics of the subscriber drop unit is completed, solder may be deposited in the channel along the bottom edge of the housing and the lip of the cover plate may be pressed into the channel in order to solder the cover plate in place. Unfortunately, when an impact force is applied to the cover plate, the cover plate is pressed inwardly and this in turn applies stresses to the solder joint that binds the cover plate to the housing. If the solder joint is cracked, the subscriber drop unit may become susceptible to damage from water or moisture ingress.

Pursuant to further aspects of the present invention, a bridge support may be mounted in the housing of a subscriber drop unit that may help protect the subscriber drop unit from damage due to impact forces that are applied to the housing or cover plate. In some embodiments, the bridge support may comprise a unitary plastic support piece that has a pair of legs and a span that extends from the first leg to the second leg. The span may also include one or more ridges. An impact force that is applied to the cover plate may be absorbed by the span and/or the ridges and carried by the span/ridges to the support legs. This may reduce or prevent the cover plate from deforming inwardly in response to the impact force, and hence may help protect the solder seams from damage. In some embodiments, the above-described ridges may be provided on the top surface of the housing and the bridge support may be installed within the housing so as to protect both the top and bottom surfaces of an subscriber drop unit from impact forces.

Example embodiments of the present invention will now be described with reference to the accompanying drawings.

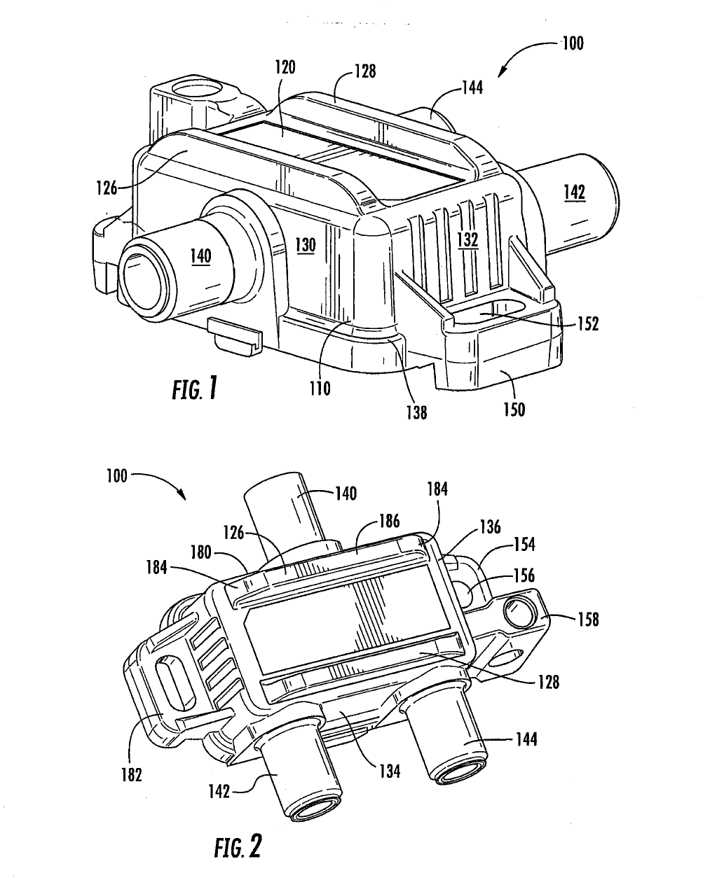

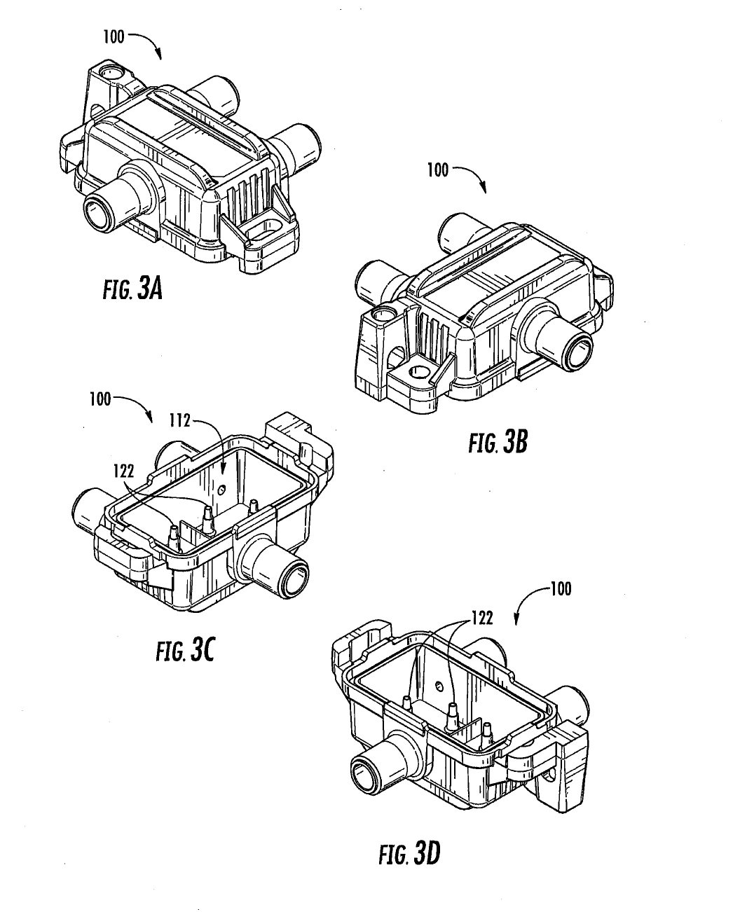

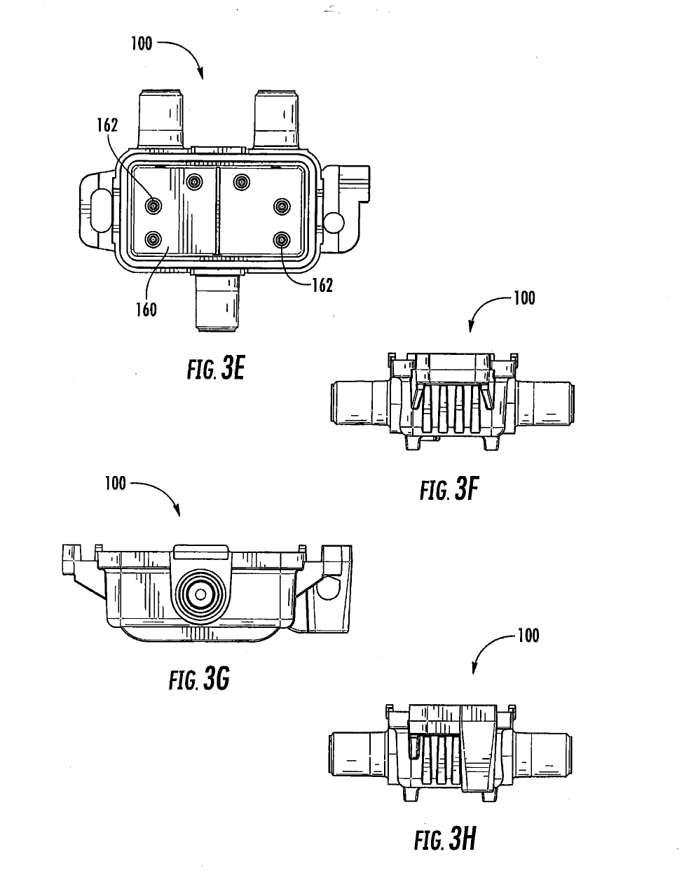

FIGS. 1-3 illustrate an RF subscriber drop unit 100 according to certain embodiments of the invention. FIG. 1 is a side perspective view of the RF subscriber drop unit 100, while FIG. 2 is a top perspective view of the RF subscriber drop unit 100. FIGS. 3A-3M are various additional views of the RF subscriber drop unit 100. In particular, FIGS. 3A-3B are top perspective views of the RF subscriber drop unit 100, FIGS. 3C-3D are bottom perspective views of the RF subscriber drop unit 100, FIG. 3E is a bottom view of the RF subscriber drop unit 100 that illustrates a printed circuit board that may be mounted within the housing, FIGS. 3F-3I are side views of the RF subscriber drop unit 100, FIG. 3J is a top view of the RF subscriber drop unit 100, FIG. 3K is a cross-sectional view of the RF subscriber drop unit 100 taken along the line 3K-3K of FIG. 3J, FIG. 3L is a top view of a cover for the RF subscriber drop unit 100 and FIG. 3M is a top view of the printed circuit board of the RF subscriber drop unit 100 after it has been removed from the housing.

The RF subscriber drop unit 100 may comprise, for example, a directional coupler or a splitter. However, it will be appreciated that the RF subscriber drop unit 100 may comprise any RF subscriber drop unit such as, for example, an RF signal amplifier, an RF tap unit, an inline filter, an RF signal conditioning device, etc.

As shown in FIGS. 1-3, the directional coupler 100 comprises a housing 110, a cover 170 (only shown in FIG. 3L) and a printed circuit board 160 (see FIGS. 3E and 3M) that includes internal circuitry (not shown). The housing 110 has a top wall 120 and a plurality of sidewalls 130, 132, 134, 136 that extend downwardly from the top wall 120. An input port 140 in the form of a first female coaxial connector port extends through the sidewall 130 and a pair of output ports 142, 144 in the form of second and third female coaxial connector ports extend through the sidewall 134. A first mounting bracket 150 that includes a slot 152 extends from a lower portion of sidewall 132. A second mounting bracket 154 that includes an aperture 156 extends from a lower portion of sidewall 136. A ground block 158 also extends from the sidewall 136.

The housing 110 may be in the shape of a generally rectangular box with an open bottom. In the depicted embodiment, the corners of the housing 110 are rounded, but they need not be in other embodiments. The lower portion or “base” of the sidewalls 130, 132, 134, 136 may include an outer lip 138.

As shown best in FIGS. 3C through 3E, the housing 110 has an open interior that defines an interior cavity 112. A plurality of protrusions 122 extend downwardly from the interior surface of the top wall 120 (note that in FIGS. 3C-3E the housing 110 is inverted to illustrate the interior cavity 112). In the depicted embodiment, the protrusions 122 comprise hollow posts that are open at their lower, distal ends. The posts 122 may or may not be internally threaded. As discussed in more detail below, a printed circuit board 160 (see FIGS. 3E and 3M) may be mounted via screws or soldering onto the distal ends of the posts 122.

As shown best in FIGS. 1-2, the exterior surface of the top wall 120 includes a pair of ridges 126, 128. In the depicted embodiment, the ridges 126, 128 extend approximately 2-3 millimeters above the remainder of the exterior surface of top wall 120, and run substantially the entire length of the top wall 120. Ridge 126 is positioned along an outer edge of top wall 120 above sidewall 130, and ridge 128 is positioned along another outer edge of top wall 120 above sidewall 134. In some embodiments, each ridge 126, 128 may have a width of between about 0.05 and 0.3 inches, a length of between about 2 and 5 inches, and a height of between about 0.1 and 0.2 inches. The housing 110 may be made of, for example, steel, zinc, aluminum, brass or a metal alloy of these or similar materials.

As noted above, a printed circuit board 160 is mounted on the posts 122 within the interior of housing 110. In some embodiments, the printed circuit board 160 is mounted on the posts 122 by screws (not shown) that are inserted through a plurality of apertures 162 in the printed circuit board 160 (see FIG. 3E) and into respective ones of the internally-threaded posts 122. Each input and output port 140, 142, 144 may include a respective contact structure (not shown) that makes physical and electrical contact with the center conductors of mating coaxial cables that are attached to the input and output ports 140, 142, 144. These contact structures may be electrically connected to components of the internal circuitry on the printed circuit board 160.

The printed circuit board 160 may include electronic components that perform the functionality of the RF subscriber drop unit 100. For example, if the RF subscriber drop unit is a splitter or directional coupler, the printed circuit board 160 may include one or more signal splitting circuits that split (or combine in the reverse direction) an input signal in a desired fashion (e.g., into two equal power output signals; into three equal power output signals; into two unequal power output signals; etc.). If the RF subscriber drop unit is a signal amplifier, the printed circuit board may include additional electronics such as diplexers, power amplifiers, voltage regulators and the like that implement the functionality of an RF signal amplifier. The printed circuit board mounted components (i.e., the internal circuitry) that implement the functionality of various RF subscriber drop units such as directional couplers, splitters, tap units, signal amplifiers, filters and the like are well known to those of skill in the art, and hence are not depicted in the drawings or described further herein.

As shown in FIG. 3L, the RF subscriber drop unit 100 includes a cover 170 that may be attached to the housing 110 via press fit compression, screws, soldering, welding or the like so that the cover 170 is joined with the housing 110 to fully enclose the printed circuit board 160 that is mounted in the interior cavity 112. Gaskets or other sealing elements (not shown) known to those of skill in the art may be provided between the cover 170 and the housing 110 to ensure that the interior cavity 112 is protected from water or moisture once the cover 170 is joined or otherwise attached to the housing 110. The cover 170 may be a generally flat piece of metal and, in some embodiments, may include apertures that serve as screw holes that are used to mount the cover 170 in place onto the housing 110. The cover 170 may also have strength apertures or other features to prevent warping.

As discussed above, the ridges 126, 128 may be designed to absorb much of the impact of an external force that may be imparted to the top wall 120 of the housing 110 during installation or use of the RF subscriber drop unit 100. In some embodiments, such as the embodiment illustrated in FIGS. 1-3, the ridges 126, 128 may be designed so that the force that is absorbed by one or both of the ridges 126, 128 when a large force such as a hammer strike is imparted onto the top wall 120 of RF subscriber drop unit 100 is transferred to one or both of the sidewalls 130, 134 of RF subscriber drop unit 100 and from there to an underlying mounting surface (e.g., a wall that the RF subscriber drop unit 100 is mounted on via the first and second mounting brackets 150, 154). Accordingly, far less force from the impact may be delivered to the printed circuit board 160 via the posts 122, thereby reducing the possibility that the printed circuit board 160 or the electronic components thereon are damaged by the impact force.

One impact test that may be used to evaluate whether or not an RF subscriber drop unit (or other electronic device) can survive certain levels of impact force is to drop a steel ball having a predetermined size and weight from a predetermined height onto the RF subscriber drop unit, and then subjecting the RF subscriber drop unit to a series of tests to determine if it still operates properly after being subjected to this impact force. The RF subscriber drop unit is also inspected for holes or cracks in the housing or other indications of damage.

In some embodiments, the ridges 126, 128 may be positioned so that the steel ball will impact one or both ridges 126, 128 as opposed to the flat exterior surface of the top wall 120. Thus, for example, if the steel ball that is used for impact testing purposes is placed on the ridges 126, 128, the ridges 126, 128 will hold the steel ball above the flat portion of the exterior surface of the top wall 120. Thus, so long as the ridges 126, 128 are sufficiently strong so that they do not deform inwardly during the ball drop test, then the ridges 126, 128 may be designed so that the steel ball will not impact the flat portion of the top wall 120 during the ball drop test.

As shown best in FIGS. 1-2, the ridges 126, 128 are positioned so that they extend upwardly from portions of the top wall 120 that are above the sidewalls 130, 134. Consequently, a significant percentage of the force imparted on the ridges 126, 128 by the external force (e.g., a hammer blow, a ball drop, etc.) may be transferred to the respective sidewalls 130, 134, greatly reducing the amount of force that is transferred to the printed circuit board 160 and the electronic components mounted thereon.

As shown in FIG. 2, in some embodiments, each ridge 126, 128 may have an exterior sidewall 180, an interior sidewall 182, a pair of end walls 184 and a top surface 186. In some embodiments, the ridges 126, 128 may be wider than the sidewalls 130, 134 that they project above. Accordingly, in such embodiments, the interior wall 182 may be positioned on a portion of the top wall 120 that is not above one of the sidewalls 130, 134. In such embodiments, the ridges 126, 128 may optionally be designed so that the exterior sidewall 180 extends farther above the top wall 120 than does the interior surface sidewall 182. As a result, a hammer or the like that impacts the ridge 126, 128 will tend to impact the exterior wall 180 before it impacts the interior wall 182. This may help direct the impact force from the hammer to be absorbed into the sidewall 130 or 134 that is below the respective ridges 126, 128 rather than by the flat portion of top wall 120 that is underneath interior wall 182.

While the ridges 126, 128 have been described as being separate structures than the top wall 120, it will be appreciated that in practice the housing 110 may be molded as an integral unit such that the top wall 120, the posts 122, the sidewalls 130, 132, 134, 136 and the ridges 126, 128 may be a single integral unit. Portions of the input port 140 and the output ports 142, 144 may likewise be formed integrally with the remainder of the housing 110 and formed in the same molding process in some embodiments. The ridges 126, 128 may be hollow.

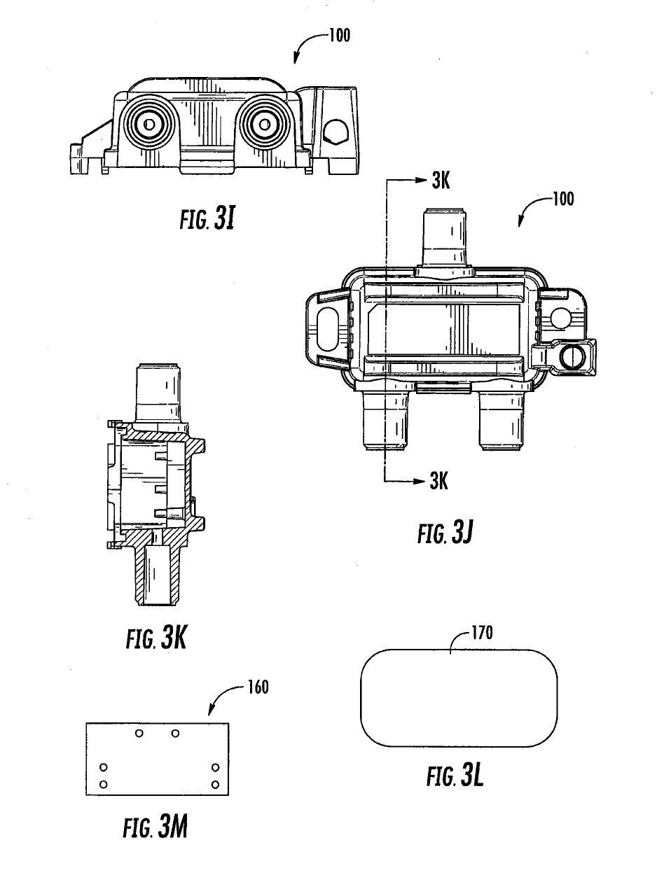

FIGS. 4A and 4B are perspective views of an RF subscriber drop unit 100′ according to further embodiments of the present invention. The RF subscriber drop unit 100′ is almost identical to the RF subscriber drop unit 100 discussed above, except that the RF subscriber drop unit 100′ includes three output ports 142, 144, 146 as compared to the two output ports 142, 144 provided on RF subscriber drop unit 100. The RF subscriber drop unit 100′ may comprise, for example, an RF splitter that splits a signal received at input port 140 into three substantially equal components (splitters split the input signal equally, while directional couplers may unequally split the input signal) that are output through the three RF output ports 142, 144, 146. The printed circuit board (not shown in the figures) included in RF subscriber drop unit 100′ may include appropriate circuitry for connecting to the three output ports 142, 144, 146, and also may include appropriate circuitry for splitting the received RF input signal into three signals having substantially equal power. Additionally, ridges 126′, 128′ are included on top wall 120′ of housing 110′. The ridges 126′, 128′ are longer than ridges 126, 128, of the embodiment of FIGS. 1-3, but otherwise may be identical to the ridges 126, 128.

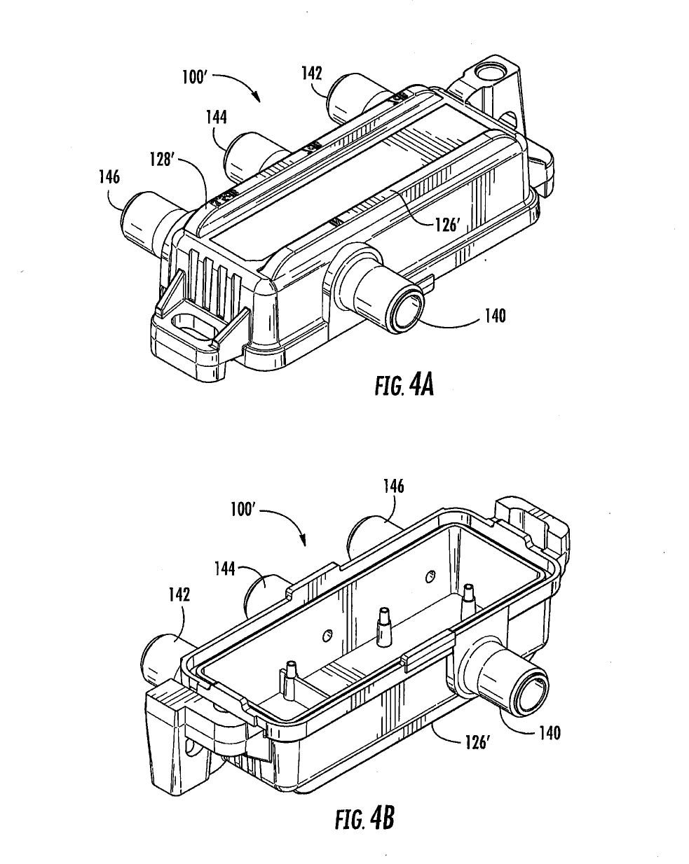

FIGS. 5A-5E are schematic perspective views that illustrate ridge designs for the top walls of subscriber drop units according to further embodiments of the present invention.

For example, in the embodiment of FIG. 5A, an RF subscriber drop unit 100-1 is provided that has ridges 126-1, 128-1. The RF subscriber drop unit 100-1 differs from RF subscriber drop unit 100 that is discussed with reference to FIGS. 1-3 above in that the ridges 126-1, 128-1 on RF subscriber drop unit 100-1 are located on the sidewalls 132, 136 (i.e., the shorter sidewalls) as opposed to being located on the sidewalls 130, 134 as is the case with RF subscriber drop unit 100. So long as the distance between the ridges 126-1, 128-1 is sufficiently small, this design will work in essentially the exact same manner as the ridges 126, 128 on RF drop unit 100.

FIG. 5B depicts another RF subscriber drop unit 100-2 that includes ridges 126-2, 128-2. In the embodiment of FIG. 5B, each ridge 126-2, 128-2 is segmented into several subunits 129. So long as the gaps 127 between the subunits 129 are sufficiently close together, the ridges 126-2, 128-2 will serve to protect the flat portions of the top wall 120 from the external force.

FIG. 5C depicts an RF subscriber drop unit 100-3 according to further embodiments of the present invention. As shown in FIG. 5C, ridges 126-3, 128-3 are provided on top wall 120 that have a zig-zag pattern. The zig-zag pattern may be advantageous when the distance between sidewalls 130, 134 that the ridges 126-3, 128-3 are positioned above is greater than a desired maximum distance between the ridges 126-3, 128-3, as the zig-zag pattern decreases the distance between the ridges 126-3, 128-3. In some embodiments, the ridges 126-3, 128-3 may include features that are designed to transfer as much of a received force as possible to the sidewalls 130, 134.

FIG. 5D illustrates an RF subscriber drop unit 100-4 according to still further embodiments of the present invention. The RF subscriber drop unit 100-4 is similar to the RF subscriber drop unit 100-3 of FIG. 5C, except that the ridges 126-4, 128-4 are curved as opposed to being in a zig-zag pattern as in the case of the ridges 126-3, 128-3 included on the RF tap unit 100-3.

FIG. 5E illustrates an RF subscriber drop unit 100-5 according to still further embodiments of the present invention. The RF subscriber drop unit 100-5 is similar to the RF subscriber drop unit 100 of FIGS. 1-3, except that the ridges 126-5, 128-5 have a variable height along their length (in the depicted embodiment the top surface of each ridge is scalloped).

It will be appreciated that combinations of the above ridge designs may be used. For example, one ridge could be straight and another ridge could have a zig-zag pattern. It will likewise be appreciated that a single ridge may include features from multiple of the above ridge designs (e.g., a straight portion and a curved portion; a segmented curve, etc.). It will likewise be appreciated that in further designs more than two ridges may be provided.

While the ridges in the above discussed embodiments are provided on the top wall of the RF subscriber drop unit in order to protect the top wall from an external force, it will be appreciated that in other embodiments ridges may alternatively or additionally be included on the sidewalls of the RF subscriber drop unit. It will likewise be appreciated that the ridges may be included on fiber optic subscriber drop units as well.

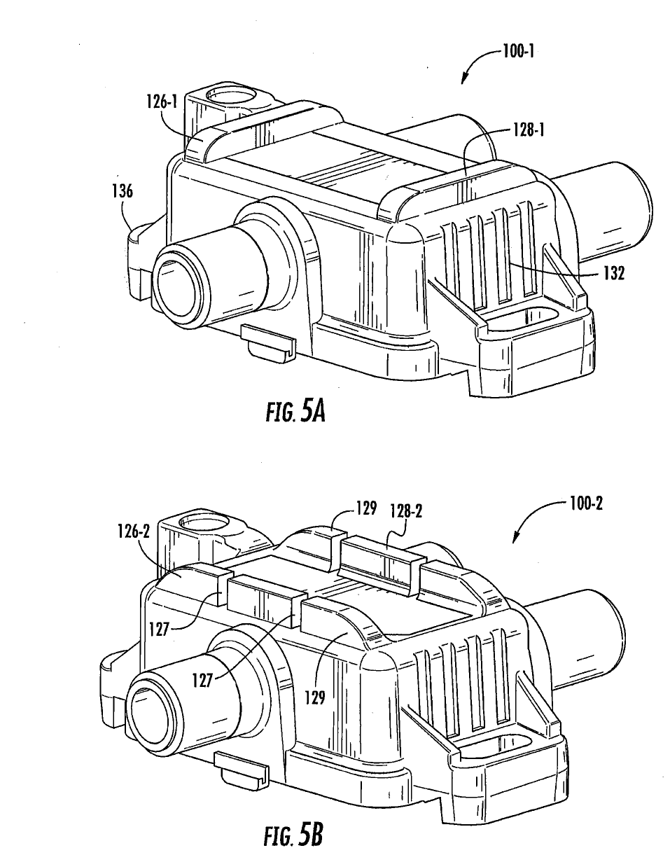

FIG. 6 is a bottom view of a housing for an RF subscriber drop unit 200 according to still further embodiments of the present invention. As shown in FIG. 6, the RF subscriber drop unit 200 has a housing 210 that has a top wall 220 and sidewalls 230, 232, 234, 236. A ledge 238 is formed in the interior surfaces of sidewalls 230, 232, 234, 236. In the embodiment of FIG. 6, the ledge 238 is formed in all four sidewalls 230, 232, 234, 236. In other embodiments, the ledge 238 may be formed in a subset of the sidewalls such as sidewalls 232 and 236. A printed circuit board (not shown) may be mounted on the ledge 238 within the housing 210 via, for example, soldering or screws.

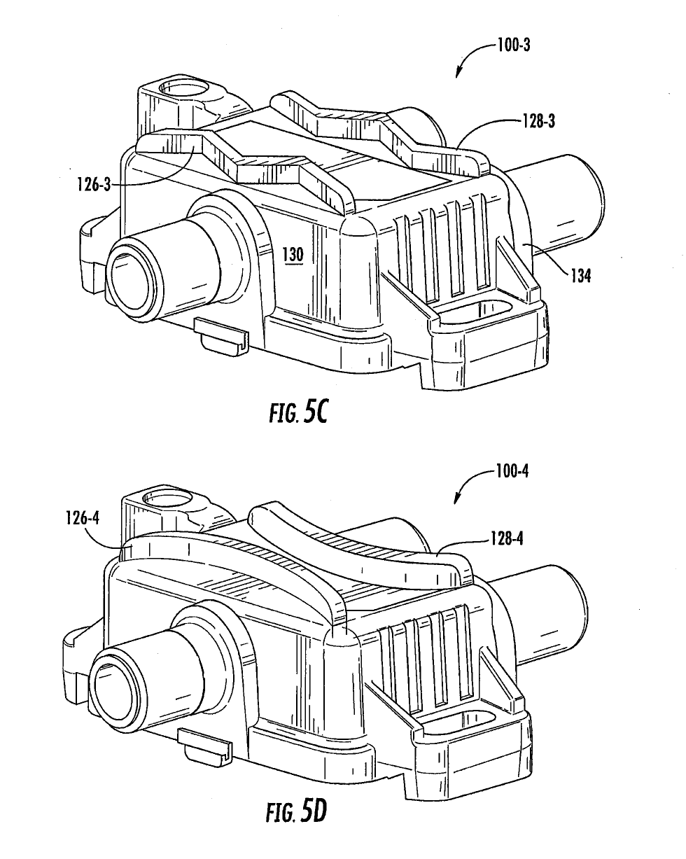

FIG. 7 is a bottom view of a housing 210′ for an RF subscriber drop unit 200′ according to yet additional embodiments of the present invention. The RF subscriber drop unit 200′ is similar to the RF subscriber drop unit 200, except that the ledge 238 of drop unit 200 is replaced in drop unit 200′ with a plurality of mounting tabs 238′. A printed circuit board (not shown) may be mounted on the mounting tabs 238′ within the housing 210′ via, for example, soldering or screws.

The housings 210, 210′ of the RF subscriber drop units 200 and 200′ of FIGS. 6 and 7 may have top walls 220 that have any of the ridge structures discussed above with respect to the embodiments of FIGS. 1-5. These ridges may absorb and/or deflect impact forces that are imparted onto the top wall 220 to the sidewalls of the housing. While some of this force may be transferred to the printed circuit boards (not shown) that are mounted within the housings 210, 210′ via the ledge 238 or the mounting tabs 238′, a significant percentage of the force may still be transferred through the sidewalls to an underlying mounting surface. Thus, the ridges (e.g., ridges 126, 128 depicted in the embodiment of FIGS. 1-3) may still act to protect the printed circuit board that is mounted within the housings 210, 210′ from damage when a force is imparted to the top walls 220 of these housings 210, 210′.

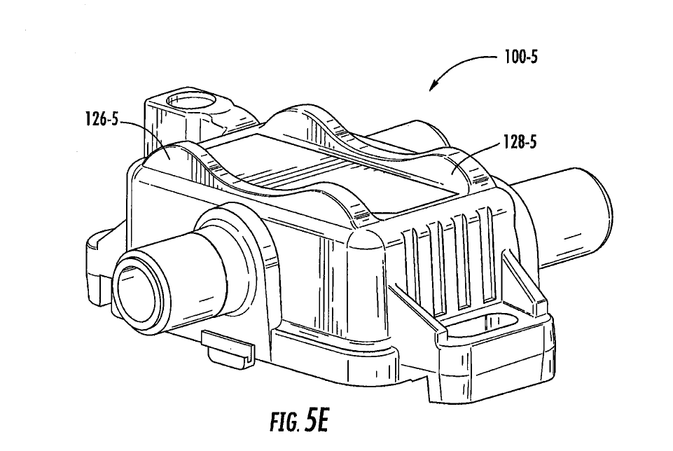

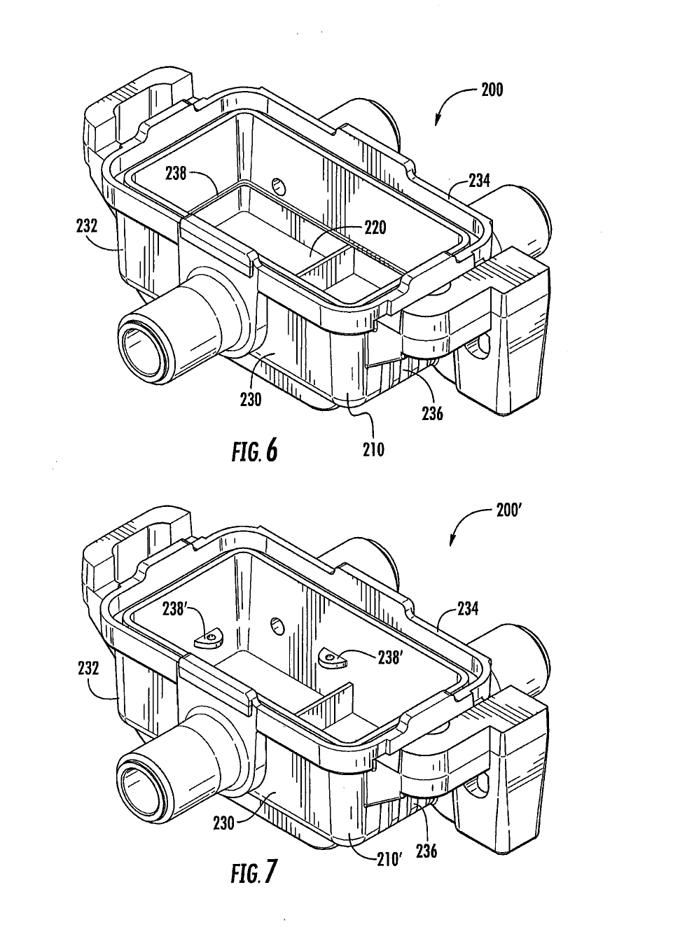

FIGS. 8-9 illustrate an RF subscriber drop unit 500 according to further embodiments of the present invention. In particular, FIG. 8 is a perspective view of a bridge support 400 that is included in the RF subscriber drop unit 500, and FIG. 9 is a cross-sectional perspective view of the RF subscriber drop unit 500 with the bridge support 400 installed therein.

As shown in FIG. 8, the bridge support 400 includes first and second spaced apart legs 410, 420 that have respective base portions 412, 422 and top portions 414, 424. The legs 410, 420 may have any appropriate shape. In the depicted embodiment, each leg 410, 420 comprises a vertical wall. Each leg 410, 420 has a recess 416, 426 in a middle bottom portion thereof. These recesses 416, 426 may receive a ground wall (not shown) that is provided on an interior surface of the top wall of the housing of the RF subscriber drop unit 500. In other embodiments the legs 410, 420 may comprise columns, arches or other shaped support structures. More than two legs may be provided. The legs 410, 420 support a span 430, as will be described below.

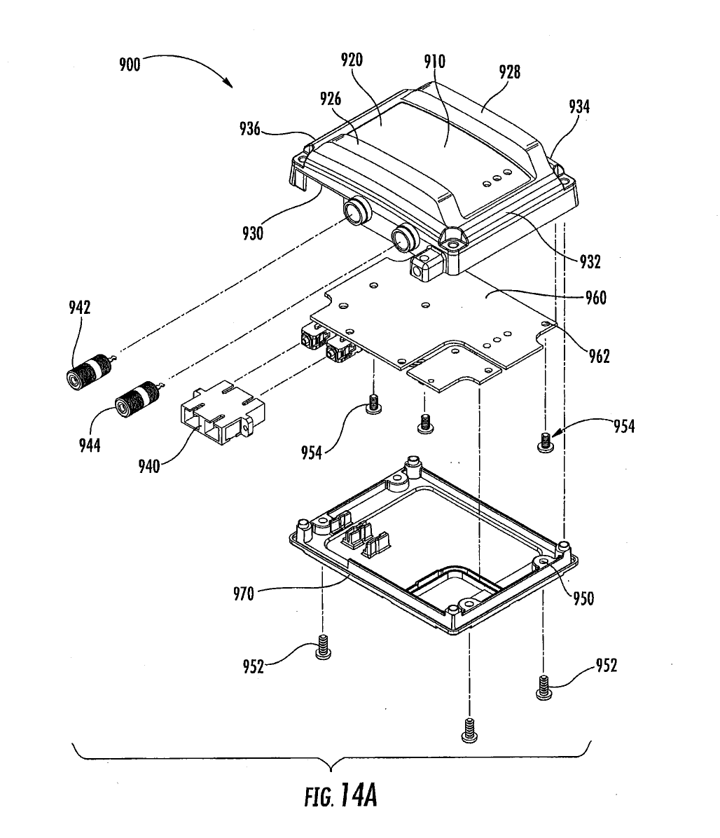

The bridge support 400 further includes a span 430 that extends from the top portion 414 of the first leg 410 to the top portion 424 of the second leg 420. In the depicted embodiment, the span 430 comprises an arch-shaped span. In other embodiments, the span 430 may have a different shape such as, for example, a horizontal span (see FIG. 13), a span having multiple arches or any other appropriate shaped span. The bridge support 400 may be formed of, for example, a polymeric material such as a plastic material. The span 430 may include one or more upwardly-extending protrusions 440. In the depicted embodiment, the upwardly-extending protrusions 440 comprise a pair of ridges 440-1, 440-2. The ridges 440-1, 440-2 may be designed to impact the interior surface of a cover plate 580 of the RF subscriber drop unit 500 when the bridge support 400 is installed within the interior of the housing 510 of the RF subscriber drop unit 500.

FIG. 9 illustrates the bridge support 400 installed within the RF subscriber drop unit 500. The RF subscriber drop unit 500 includes a housing 510 that has top wall 520 and sidewalls 530, 532, 534 that extend downwardly from the top wall 520 (a fourth sidewall is provided that is not visible in the cross-sectional view of FIG. 9). The housing 510 has an open interior that defines an interior cavity 512. A plurality of posts 522 extend downwardly from the interior surface of the top wall 520. A printed circuit board 560 is mounted on the distal ends of the posts 522. An input port 540 in the form of a first female coaxial connector port extends through the top wall 520 as does an output port 542 in the form of a second female coaxial connector port. The lower portion or “base” of the sidewalls 530, 532 may include a channel 538. A cover 580 is mounted to cover the bottom of the housing 510. The cover 580 includes a raised lip 582 that is configured to reside in the channel 538 when the cover 580 is mounted to cover the bottom of housing 510. The RF subscriber drop unit 500 is pictured in an inverted position in FIG. 9 so that the top wall 520 is at the bottom of the figure and the cover plate 580 is at the top of the figure.

As shown in FIG. 9, the bridge support 400 is received within the interior 512 of housing 510. The base 412, 422 of legs 410, 420 may be received within respective channels 514, 516 that are formed along the interior of the top wall 520. The arch-shaped span 430 extends between the legs 410, 420. The cover plate 580 may directly contact the span 430. The printed circuit board 560 may be mounted between the legs 410, 420 and above the span 430. The ridges 440 extend between the legs 410, 420 and are parallel to the cross-section of FIG. 9 (note that the cross-section is taken through ridge 440-1).

Operation of the bridge support 400 will now be described with reference to FIGS. 8 and 9. During installation or use of the RF subscriber drop unit 500, impact forces such as, for example, hammer blows, may be applied to the cover plate 580 of RF subscriber drop unit 500. If the bridge support 400 is not included in the RF subscriber drop unit 500, then this impact force may damage the RF subscriber drop unit 500 in several ways. For example, the impact force may crack the cover plate 580 or leave a dent in the cover plate 580. Such physical damage to the cover plate will typically result in the RF subscriber drop unit 500 being deemed unsuitable for use. Additionally, a solder seam in the channel 538 that is used to solder the cover plate 580 to the housing 510 may crack when the cover plate 580 deflects inwardly in response to the impact force. Also, the impact force may be transferred from the cover plate 580, through the sidewalls 530, 532, 534, to the top wall 520 and to the printed circuit board 560 through the posts 522. This may result in damage to the printed circuit board 560 of electronic components provided thereon.

When the bridge support 400 is provided within the housing 510, the ridges 440-1, 440-2 and the top portion of the span 430 may be configured to directly contact an interior surface of the cover plate 580 when the cover plate 580 is soldered in place to cover the bottom of the housing 510. If the impact force is applied in the center of the cover plate 580, much of the impact force may be transferred through the cover plate 580 to a top portion 432 of the span 430. This force is transferred from the top 432 of span 430 the arch-shaped span 430 to the legs 410, 420, where the force may be partially absorbed by the polymeric material and partially transferred to the top wall 520 of the housing 510. With respect to many impact forces, the provision of the bridge support 400 may be sufficient to reduce or prevent the cover plate 580 or the solder seam from being cracked or deformed. In some cases, the impact force may not be applied to the center section of the cover plate 580, but may instead be applied adjacent one of the side walls 530, 532, 534. The ridges 440-1, 440-2 are provided so that the bridge support 400 may include a structure that contacts the interior of the cover plate 580 underneath or near the location of any impact force. Impact forces that are applied outside the center section of the cover plate 580 may be transferred through the cover plate 580 to one or both of the ridges 440-1, 440-2, where the impact force may be absorbed and/or transferred to the legs 410, 420 and the top plate 520 of the housing 510. As the bridge support 400 may absorb a portion of the impact force, the bridge support 400 may also protect the printed circuit board 560 from damage.

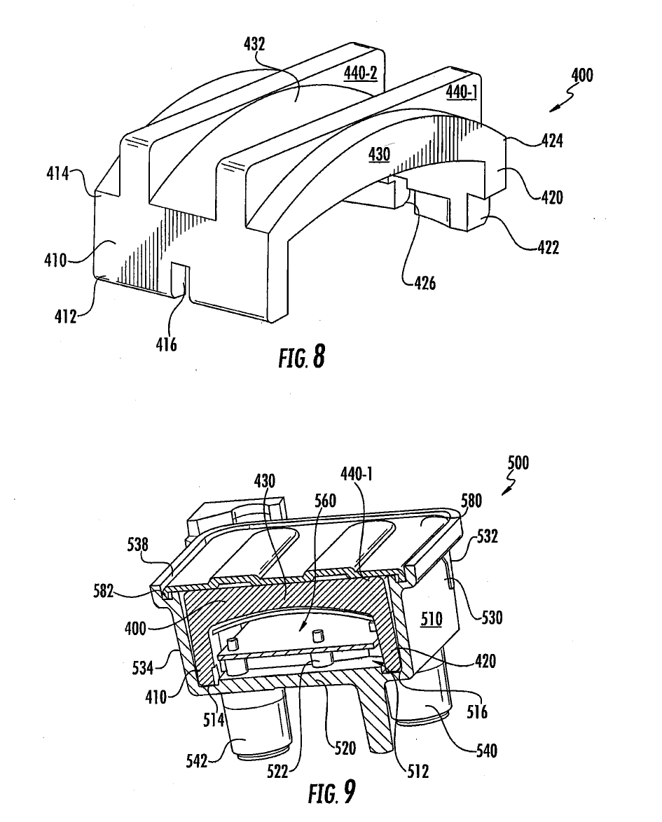

It will be appreciated that many modifications may be made to the bridge structure 400 without departing from the teachings of the present invention. FIGS. 10-13 illustrate other example bridge structures according to further embodiments of the present invention. It will be appreciated that these additional example embodiments are non-limiting and are only provided to illustrate other example implementations.

As shown in FIG. 10, a bridge structure 600 is similar to the bridge structure 400, except that it includes four legs 610, 615, 620, one along each side of the bridge support (the fourth leg is not visible in FIG. 10, but is opposite leg 615). In the depicted embodiment, each leg 610, 615, 620 is implemented as a wall, but it will be appreciated that other leg structures may be used.

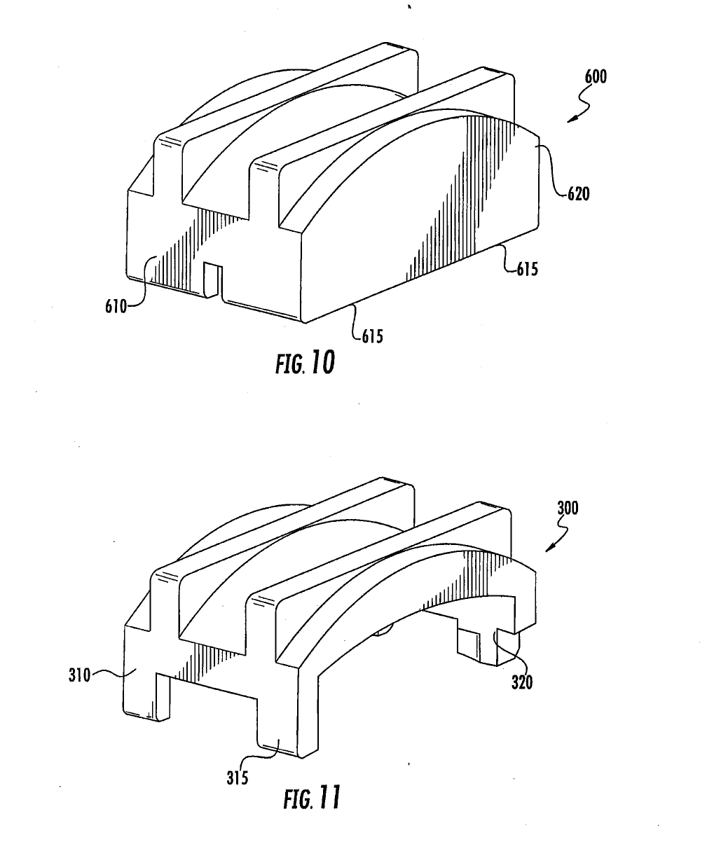

As shown in FIG. 11, in another embodiment a bridge structure 300 is provided that is also similar to the bridge structure 400, except that the wall-type leg structures 410, 420 of the bridge support 400 are replaced with column-type legs 310, 315, 320 in the bridge structure 300 (a fourth leg may also be provided that is not visible in the view of FIG. 11).

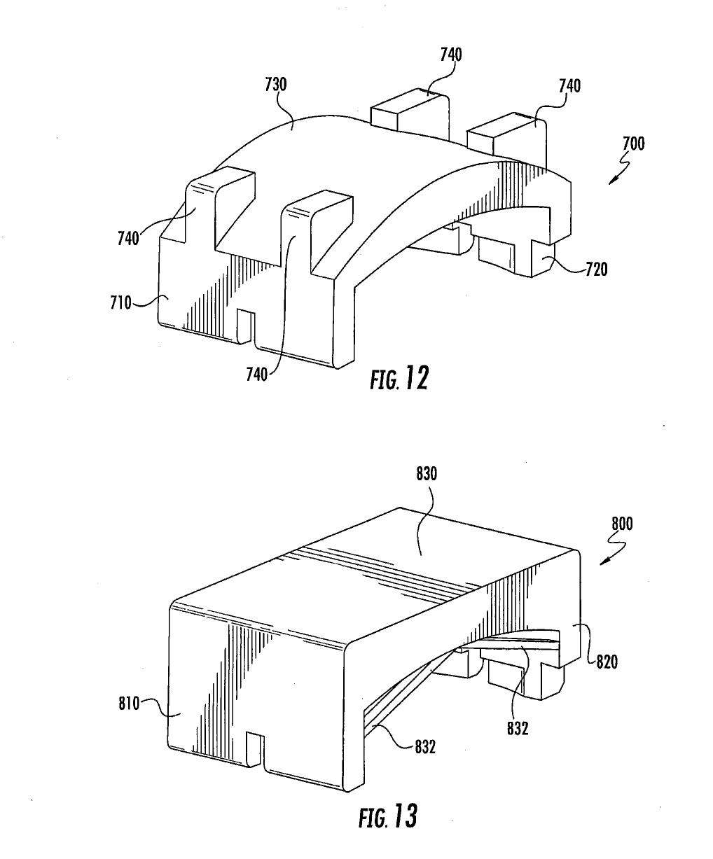

As shown in FIG. 12, in another embodiment a bridge structure 700 is provided that is also similar to the bridge structure 400, except that the ridges 440-1, 440-2 of the bridge support 400 are replaced with column supports 740 in the bridge structure 700. The column supports 740 may contact an interior surface of the cover plate 580 of the RF subscriber drop unit 500. The column supports 740 may transfer the impact force to the span 730, which absorbs the force and/or transfers it to the legs 710, 720. The column supports 740 may have any appropriate shape. It will be appreciated that upwardly extending protrusions other than ridges (FIG. 8) or columns (FIG. 12) may also be used.

As shown in FIG. 13, in yet another embodiment a bridge support 800 is provided that has a horizontal span 830 that replaces the arch-shaped span 430 of the bridge support of FIG. 8. One or more support ribs 832 may be provided. Each support rib 832 may have a first end that extends from either the first leg 810 or the second leg 820 and a second end that extends from the span 830. The support ribs 832 may transfer forces applied to the span to the first and second legs 810, 820.

It will be appreciated that the bridge supports according to embodiments of the present invention may be used in RF subscriber drop units that include housings having ridges that protect the top of the housing from impact forces, such as the housings described above with reference to FIGS. 1-7. It will also be appreciated that the bridge supports according to embodiments of the present invention may be used in any type of RF subscriber drop unit such as, for example, an RF signal amplifier, an RF tap unit, an inline filter, an RF signal conditioning device, etc.

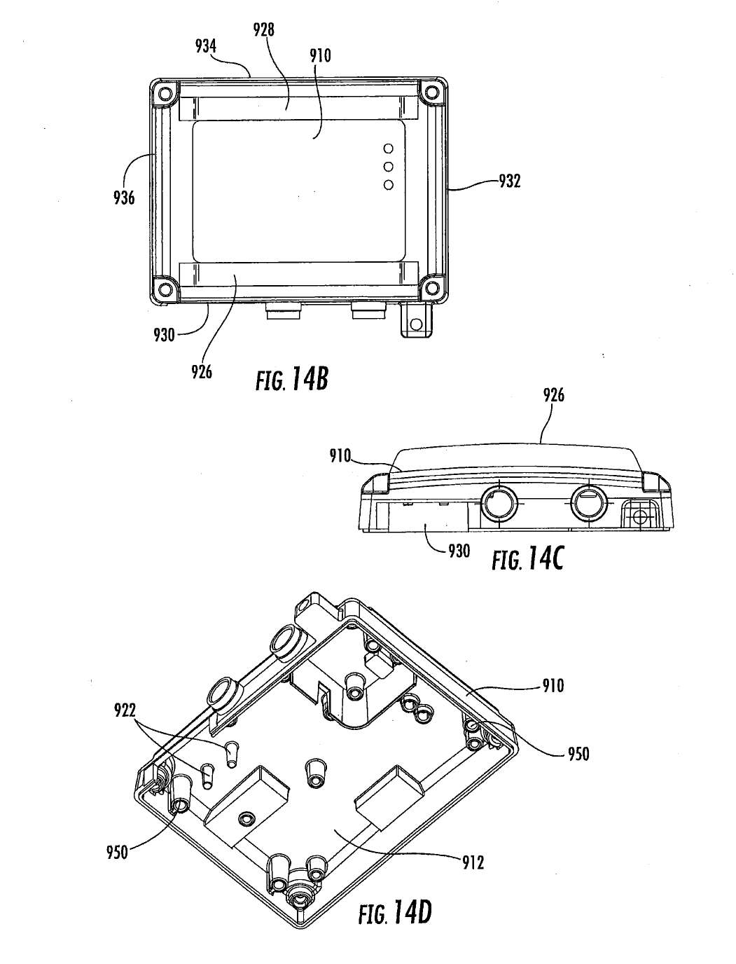

FIGS. 14A-14D illustrate a fiber optic subscriber drop unit 900 in the form of a micro node according to further embodiments of the invention. In particular, FIG. 14A is an exploded perspective view of the micro node 900, while FIGS. 14B-14D are top, side and bottom perspective views of the housing 910 of the micro node 900. While in FIGS. 14A-14D a micro node is illustrated as an exemplary fiber optic subscriber drop unit, it will be appreciated that any fiber optic subscriber drop unit may be modified to include the ridges illustrated in FIGS. 14A-14D.

As shown in FIGS. 14A-14D, the micro node 900 includes a housing 910, a cover plate 970 and a printed circuit board 960 that includes internal circuitry (not shown). The housing 910 has a top wall 920 and a plurality of sidewalls 930, 932, 934, 936 that extend downwardly from the top wall 920. An input port 940 in the form of a dual SC fiber optic adapter extends through the sidewall 930 and a pair of output ports 942, 944 in the form of first and second female coaxial connector ports also extend through the sidewall 930. The housing 910 and cover plate 970 each include a plurality of apertures 950 in matched alignment. A plurality of screws 952 are threaded through these apertures to attach the cover plate 970 to the housing 910. While not shown, the housing 910 may include one or more mounting brackets or other apertures that, in may be used to mount the micro node 900 to a surface such as a wall of a subscriber premise. For example, nails and/or screws may be inserted through the apertures to mount the micro node 900 to the surface.

As shown best in FIGS. 14A and 14D, the housing 910 may be in the shape of a generally rectangular box with an open bottom that defines an interior cavity 912. A plurality of protrusions 922 extend downwardly from the interior surface of the top wall 920. In the depicted embodiment, the protrusions 922 comprise hollow threaded posts that are open at their lower, distal ends. As shown in FIG. 14A, the printed circuit board 960 may be mounted via screws 954 to the distal ends of the posts 922.

As shown in FIGS. 14A-14C, the exterior surface of the top wall 920 includes a pair of ridges 926, 928. In the depicted embodiment, the ridges 926, 928 run substantially the entire length of the top wall 920. Ridge 926 is positioned along an outer edge of top wall 920 above sidewall 930, and ridge 928 is positioned along another outer edge of top wall 920 above sidewall 934. In some embodiments, each ridge 926, 928 may have a width of between about 0.05 and 0.3 inches, a length of between about 2 and 5 inches, and a height of between about 0.1 and 0.2 inches. The housing 910 may be made of, for example, steel, zinc, aluminum, brass or a metal alloy of these or similar materials, or may comprise a non-metal housing such as, for example, a plastic housing.

The printed circuit board 960 is mounted on the posts 922 within the interior 912 of housing 910 by screws 954 that are inserted through a plurality of apertures 962 in the printed circuit board 60 and into respective ones of the internally-threaded posts 922. Each input and output port 940, 942, 944 may include a respective structure (not shown) that allows signals to be transmitted to and from the printed circuit board 960 to the respective input/output port 940, 942, 944.

The printed circuit board 960 may include optical and electronic components that perform the functionality of the micro node 900 including, for example, optical-to-RF and RF-to-optical conversion units. The printed circuit board mounted components (i.e., the internal circuitry) that implement the functionality of a micro node 900 are well known to those of skill in the art, and hence are not depicted in the drawings or described further herein.

As shown in FIG. 14A, the micro node 900 includes a cover 970 that may be attached to the housing 910 via screws 952 so that the cover 970 is joined with the housing 910 to fully enclose the printed circuit board 960 that is mounted in the interior cavity 912. Gaskets or other sealing elements (not shown) known to those of skill in the art may be provided between the cover 970 and the housing 910 to ensure that the interior cavity 912 is protected from water or moisture once the cover 970 is joined or otherwise attached to the housing 910.

The ridges 926, 928 may be designed to absorb much of the impact of an external force that may be imparted to the top wall 920 of the housing 910 during installation or use of the micro node 900. In some embodiments, the ridges 926, 928 are positioned so that they extend upwardly from portions of the top wall 920 that are above the sidewalls 930, 934. Consequently, a significant percentage of the force imparted on the ridges 926, 928 by the external force may be transferred to one or both of the sidewalls 930, 934 of micro node 900 and from there to an underlying mounting surface. Accordingly, far less force from the impact may be delivered to the printed circuit board 960 via the posts 922, thereby reducing the possibility that the printed circuit board 960 or the optical/electronic components thereon are damaged by the impact force.

While the ridges 926, 928 have been described as being separate structures than the top wall 920, it will be appreciated that in practice the housing 910 may be molded as an integral unit such that the top wall 920, the posts 922, the sidewalls 930, 932, 934, 936 and the ridges 926, 928 may be a single integral unit. The ridges 926, 928 may be hollow. It will also be appreciated that any appropriate ridge design may be used including, for example, the ridge designs illustrated in FIGS. 5A-5E as place of the ridge design illustrated in FIGS. 14A-14D.

While not shown in FIGS. 14A-14D, It will be appreciated that the bridge supports according to embodiments of the present invention illustrated in FIGS. 8-13 may likewise be used in fiber optic subscriber drop units that include housings having ridges that protect the cover plate 970 of the housing from impact forces, such as the housing 910 of the micro node 900 described above with reference to FIGS. 14A-14D. It will also be appreciated that the bridge supports according to embodiments of the present invention may also be used in fiber optic subscriber drop units having housings that do not include external ridges.

The present invention is not limited to the illustrated embodiments discussed above; rather, these embodiments are intended to fully and completely disclose the invention to those skilled in this art. In the drawings, like numbers refer to like elements throughout.

In the description above, spatially relative terms, such as “top,” “bottom,” “side,” “upper,” “lower” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, integers, steps, operations, elements, and/or components, but do not preclude the presence or addition of one or more other features, integers, steps, operations, elements, components, and/or groups thereof.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

All of the above-described embodiments may be combined in any way to provide a plurality of additional embodiments.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A subscriber drop unit, comprising:
a housing having a top wall that has an exterior surface and an interior surface and a plurality of sidewalls that extend downwardly from the top wall, the top wall and the sidewalls defining an interior cavity;
an input port that extends through the housing;
at least one output port that extends through the housing;
a printed circuit board mounted within the interior cavity,
wherein the exterior surface of the top wall includes a first ridge that extends upwardly above a first of the sidewalls and a second ridge that extends upwardly above a second of the sidewalls.

2. The subscriber drop unit of claim 1, wherein the top wall includes a plurality of protrusions that extend downwardly from the interior surface of the top wall into the interior cavity, and wherein the printed circuit board is mounted on the plurality of protrusions.

3. The subscriber drop unit of claim 1, wherein at least two of the sidewalls having printed circuit board mounting features on interior surfaces thereof, and wherein the printed circuit board is mounted on the printed circuit board mounting features.

4-6. (canceled)

7. The subscriber drop unit of claim 1, wherein the first and second ridges are configured to transfer at least half the force imparted on the first and second ridges when a vertical force is imparted on top surfaces of the first and second ridges to the first and second sidewalls.

8-10. (canceled)

11. The subscriber drop unit of claim 1, wherein a first height of an exterior sidewall of the first ridge exceeds a second height of an interior sidewall of the first ridge.

12. The subscriber drop unit of claim 2, wherein the plurality of protrusions comprise a plurality of posts.

13-14. (canceled)

15. A subscriber drop unit, comprising:
a housing having a top wall that has an exterior surface and an interior surface and a plurality of sidewalls that extend downwardly from the top wall, the top wall and the sidewalls defining an interior cavity, at least two of the sidewalls having printed circuit board mounting features on interior surfaces thereof;
an input port that extends through the housing;
at least one output port that extends through the housing;
a printed circuit board mounted within the interior cavity on the printed circuit board mounting features of the at least first and second of the sidewalls,
wherein the exterior surface of the top wall has a plurality of ridges.

16. The subscriber drop unit of claim 15, wherein the printed circuit board mounting features comprise at least one mounting tab on the first of the sidewalls that extends inwardly from the first of the sidewalls into the interior cavity and at least one mounting tab on the second of the sidewalls that extends inwardly from the second of the sidewalls into the interior cavity.

17. The subscriber drop unit of claim 15, wherein the printed circuit board mounting features comprise a first ledge in the interior surface of a first of the sidewalls and a second ledge in the interior surface of a second of the sidewalls.

18. (canceled)

19. The subscriber drop unit of claim 15, wherein a first of the plurality of ridges extends upwardly from the top wall at least partially above a first of the sidewalls and a second of the plurality of ridges extends upwardly from the top wall at least partially above a second of the sidewalls.

20. The subscriber drop unit of claim 19, wherein the at least two of the sidewalls that have printed circuit board mounting features comprise third and fourth sidewalls.

21. A subscriber drop unit, comprising:
a housing having a top wall and a plurality of sidewalls that extend downwardly from the top wall, the top wall and the sidewalls defining an interior cavity and the housing having an open bottom;
a cover plate that covers the open bottom of the housing;
a printed circuit board mounted within the interior cavity;
a bridge support having first and second legs and a span extending therebetween,
wherein the span is positioned adjacent the cover plate and the first and second legs are positioned adjacent an interior surface of the top wall of the housing.

22. The subscriber drop unit of claim 21, wherein the printed circuit board is mounted between the first leg and the second leg.

23. The subscriber drop unit of claim 21, wherein the span includes at least one upwardly extending protrusion.

24-26. (canceled)

27. The subscriber drop unit of claim 21, wherein an exterior surface of the top wall includes a first ridge that extends upwardly above a first of the sidewalls and a second ridge that extends upwardly above a second of the sidewalls.

28. The subscriber drop unit of claim 27, wherein the top wall includes a plurality of protrusions that extend downwardly from the interior surface of the top wall into the interior cavity, and wherein the printed circuit board is mounted on the plurality of protrusions.

29. The subscriber drop unit of claim 21, wherein the bridge support is formed of a polymeric material.

30-36. (canceled)

37. The subscriber drop unit of claim 29, wherein the span of the bridge support is in direct contact with an interior surface of the cover plate and the first and second legs are in direct contact with an interior surface of the top wall.

38. The subscriber drop unit of claim 1, further comprising a polymeric bridge support having first and second legs positioned adjacent an interior surface of the top wall of the housing and a span extending between the first and second legs that is positioned adjacent a cover plate that covers an opening into the interior cavity.

39. The subscriber drop unit of claim 15, further comprising a polymeric bridge support having first and second legs positioned adjacent an interior surface of the top wall of the housing and a span extending between the first and second legs that is positioned adjacent a cover plate that covers an opening into the interior cavity.
